(19) United States
(12) Patent Application Publication
(10) Pub. No.: US 2007/0286681 A1
(43) Pub. Date: Dec. 13, 2007

(54) Line laying apparatus

(76) Inventor: Michel Parent, Montreal (CA)

Correspondence Address: Franz Bonsang;c/o PROTECTIONS EQUINOX INT'L INC., Suite 224, 4480, Cote-de-Liesse, Montreal, QC, H4N 2R1, US

(21) Appl. No.: 11/451,434

(22) Filed: Jun. 13, 2006

(51) Int. Cl. F16L 1/028

(52) U.S. Cl. 405/174

(57) ABSTRACT

A mole-plough for forming a subterranean channel for laying a line includes a body incorporating a leading edge and nose for cutting the channel, a guide plate on the body located at the desired terrain surface level, an arcuate passage within the body for feeding each line to be laid, and a stabilizer disposed adjacent the exit of the passage and extending rearwardly of the body.

### FIELD OF THE INVENTION

The present invention relates to apparatus for the laying of lines such as cables, wires, pipes or other elongate relatively flexible lines in a subterranean channel.

More specifically the invention has reference to a mole-plough for forming the subterranean channel and simultaneously feeding the line thereinto.

### BACKGROUND OF THE INVENTION

The subterranean placement of lines, for example inter alia power lines, water pipes and the like, is well known and practiced and generally involves the cutting of a trench or channel within which the lines are laid in the wake of the cutting stage.

In some existing apparatus such for example as that disclosed in U.S. Pat. No. 3,760,595 to Stewart et al. a digging mole is hauled through the ground to form the subterranean channel and the line is then dragged through the channel to its fullest extent thus leaving the line in a recumbent position in the floor of the channel.

In other prior art proposals, for example those set forth in U.S. Pat. No. 4,318,638 to Promersberger et al., U.S. Pat. No. 4,661,019 to McLaughlin, and U.S. Pat. No. 4,890,958 to Dancer a channel cutting tool in the form of a blade precedes the laying of the line in the channel, the line being fed into the channel by a chute or other guide.

The prior art displays the principal disadvantage of employing complicated mechanisms which are expensive in terms of cost and maintenance.

Accordingly, there is a need for an improved means of laying lines involving simplicity and efficiency of operation.

### SUMMARY OF THE INVENTION

It is therefore a general object of the present invention to provide an improved mole-plough for use in the subterranean laying of lines.

A further object of the invention is to provide such a mole-plough which combines the function of a plough for forming a sub-surface channel or trench with line laying using an integrated guiding arrangement for the line(s).

Another object of the present invention is the provision of a stabilizer for assisting in the formation of a constant depth channel.

A still further object of the invention is the provision of a stabilizer for giving stability to the mole-plough and protection for the line(s) being laid when in use.

Accordingly the invention provides as a first aspect a mole-plough suitable for the subterranean laying of lines comprising a body, a leading cutting edge to the body forming a share for ploughing into the terrain with a nose at the foot of the cutting edge, a guide plate provided on the body at a level coincident with the desired depth of cut for guiding the mole-plough along a constant path, an attachment means for connecting the mole-plough to a traction unit, at least one open-ended internal passage for accommodating and guiding a line, the passage being formed within the body and extending from a leading upper portion of the body to a rearward lower portion thereof adjacent the base of the mole-plough, and a stabilizer located at said rearward lower portion, the nose protruding downwardly in relation to the body and defining a step therebetween.

Conveniently the nose may be of hardened material to withstand wear that may be occasioned by encountering hard ground or stones lying therewithin.

The guide plate is positioned at said level such as to be visible in use to enable an operative to observe and to maintain a constant depth of cut. The guide plate may be profiled at its leading edge and on its upper and lower surfaces to reduce drag.

The said at least one passage preferably follows an arcuate path of relatively large curvature in order to provide a smooth run for the line running therewithin.

Advantageously, the entry and the discharge ends of said passage may be provided with guide tubes of relatively short length to assist in use the guiding of the line into and out of the passage at the entry and discharge ends thereof respectively.

More than one passage may be provided in the body.

The stabilizer may conveniently be disposed on the rearward or trailing portion of the body at the relatively lower level thereof and is preferably horizontally oriented. The stabilizer may further be located above the level of the discharge end of the passage.

The attachment means may be of any form suitable for connection to a conventional traction unit such as a tractor with a front end loader and/or a backhoe, a bucket excavator or the like vehicle.

According to a second aspect of the present invention there is provided line laying apparatus comprising in combination a mole-plough according to the first aspect, a traction unit adapted for connection to the attachment means of the mole-plough, the traction unit having at least one line guide reel mounted thereon, and a line feeding unit adapted to follow the traction unit and the mole-plough and having mounted thereon feed drums providing a line supply to the mole-plough for laying in the subterranean channel formed thereby.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic view of the mole-plough according to the invention shown in a working mode submerged into a subterranean position and connected to a traction unit; and

FIG. 2 is a perspective side view of the mole-plough per se.

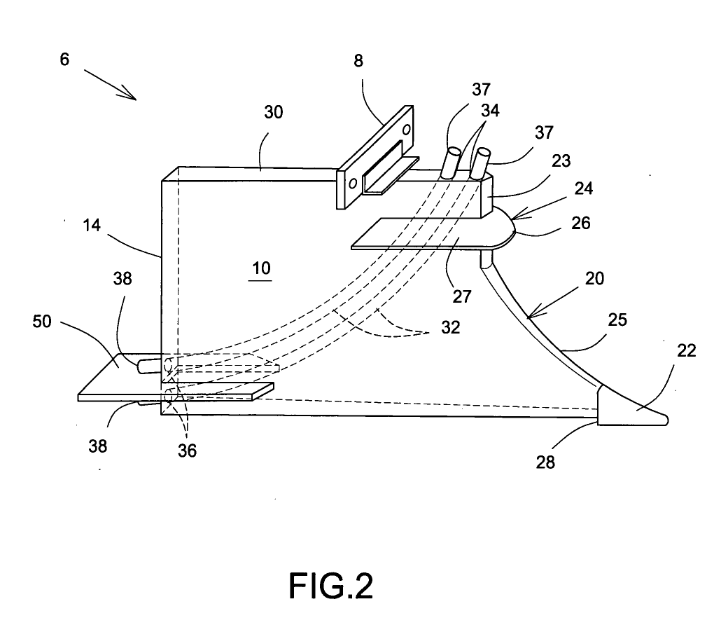

### DETAILED DESCRIPTION OF THE PREFERRED EMBODIMENTS

With reference to the annexed drawings the preferred embodiment of a mole-plough according to the present invention will be herein described for indicative purpose and by no means as of limitation.

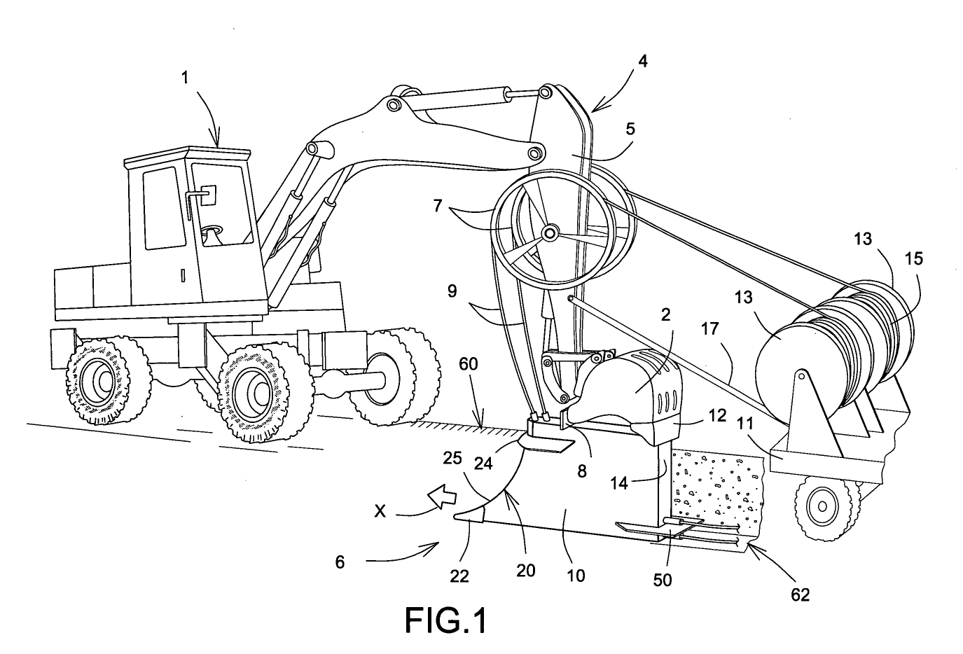

In FIG. 1 there is illustrated a traction unit in the form of an excavator 1 having an excavator bucket 2 mounted for pivoting movement on an arm arrangement 4 provided on the excavator. The arm arrangement 4 and the pivoting movement of the bucket 2 are hydraulically actuable in conventional manner. One limb 5 of the arm arrangement 4 is provided with guide wheels 7 one for each of two lines 9 shown being fed to a mole-plough 6. A line supply vehicle 11 has feed drums 13 loaded with reeved lines 15 for supplying the mole-plough. A connecting linkage is schematically shown at 17 in FIG. 1 and extends from the vehicle 11 to the arm arrangement 4 whereby in use the vehicle is hauled as a trailer by the excavator.

The mole-plough 6 is shown in FIG. 1 as being hauled in the direction of arrow X by the excavator 1 and for this purpose an attachment means 8 is provided on the body 10 of the mole-plough 6, the bucket 2 abutting the means 8 with its leading edge 12 hooking over the trailing edge 14 of the body 10.

The body 10 of the mole-plough 6 has a leading edge 20 in the manner of a share with a shaped hardened steel nose 22 at its foot, the leading edge being of curvilinear form with an essentially vertical part 23 at the top of the edge 20 leading to a curved section 25 and ultimately to the nose 22. There is on this vertical part 23 a substantially horizontal guide plate 24 having a rounded front 26 and contoured sides 27 which embrace the vertical part 23 as shown.

The shaped hardened steel nose 22 is of slightly wider dimension in its height at its trailing part by having a step 28 protruding downwardly from the body 10 such as to provide in use clearance and thus smoother sliding and passage through the terrain.

The guide plate 24 is set at a level such as to provide a visible indication of the depth position of the mole-plough 6 and a physical constraint to maintain constancy of depth penetration into the subterranean strata.

The body 10 has a top edge 30 on which is mounted the attachment means 8 and a rearward or trailing edge 14. In this embodiment of the present invention there are formed within the body 10 two passages 32 for the feeding therethrough and guidance of the lines 9 supplied from the reeved lines 15 wound on the feed drums 13. The passages 32 are of circular section and of arcuate shape as between their entries 34 and their exits 36. The entries and the exits are provided with short guide tubes 37, 38 for ensuring smooth and positive entry and exit for the lines 9 during their guidance therethrough.

A stabilizer 50 is positioned on the trailing edge 14 in the vicinity of the exits 36 and their tubes 38 and embraces the sides of the body 10 of the mole-plough 6 as shown. In this example of the present invention, the stabilizer extends horizontally rearwards of the body at the level indicated and lies between the two guide tubes 38.

In operation the mole-plough 6 is coupled to the excavator 1 which in turn is in towing relationship with the line carrying supply vehicle 11 as shown in and described in relation to FIG. 1. As the excavator 1 moves in the direction of arrow X the mole-plough 6 is hauled through the terrain 60 to create a narrow channel 62; it will be understood that initially the excavator 1 creates a clearance trench for the initial descent of the mole-plough 6 into the terrain 60. Progress of the excavator 1, the mole-plough 6 and vehicle 11 in the direction of arrow X generates the narrow channel 62 into which the lines 9 are laid via the passages 32 in the body 10 of the mole-plough, the lines 9 exiting the body in the manner illustrated onto the floor of the channel 62 before the overhanging earth displaced by the advance of the mole-plough falls onto the lines now laid in the channel.

The guide plate 24 should remain visible during advance of the excavator 1 whose operative should be vigilant to rectify any deviation, the purpose of the guide plate being to indicate the correct level of submersion within the terrain and to maintain that level as predetermined by the particular disposition of the plate on the body of the mole-plough.

In concert with the function of the guide plate 24 the stabilizer 50 serves to maintain a correct line at its level on the body and to prevent any sharp vertical deviations that may be experienced by the mole-plough encountering resistance, for example the presence of a rock. Furthermore in extending rearwardly in association with the exits for the lines 9 the descent of previously displaced earth is momentarily prevented and the lines protected thereby. The lines 9 thus emerge into the channel 62 without the impact of extraneous matter. The arcuate nature of the passages 32 also ensure smooth travel for the lines from the drums 13 via the guide wheels 7 exiting ultimately through the guide tubes 38 into the channel 62.

The present invention thus presents a means of laying lines in a subterranean channel smoothly by the use of a self-contained mole-plough with integrated guidance passages, coupled with the provision of a guide plate and a stabilizer respectively at the top and the bottom of the body of the mole-plough.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A mole-plough suitable for the subterranean laying of lines comprising a body, a leading cutting edge to the body forming a share for ploughing into the terrain with a nose at the foot of the cutting edge, a guide plate provided on the body at a level coincident with the desired depth of cut for guiding the mole-plough along a constant path, an attachment means for connecting the mole-plough to a traction unit, at least one open-ended internal passage for accommodating and guiding a line, the passage being formed within the body and extending from a leading upper portion of the body to a rearward lower portion thereof adjacent the base of the mole-plough, and a stabilizer located at said rearward lower portion, the nose protruding downwardly in relation to the body and defining a step therebetween.

2. A mole-plough according to claim 1 wherein the guide plate is positioned at said level such as to be visible in use to enable an operative to observe and to maintain a constant depth of cut.

3. A mole-plough according to claim 1 wherein the guide plate is profiled at its leading edge and on its upper and lower surfaces to reduce drag.

4. A mole-plough according to claim 3 wherein the said at least one passage follows an arcuate path of relatively large curvature.

5. A mole-plough according to claim 4 wherein the said at least one passage is provided with an entry and a discharge end, said entry and discharge ends of said passage being provided with guide tubes of relatively short length to assist in use the guiding of the line into and out of the passage at the entry and discharge ends thereof respectively.

6. A mole-plough according to claim 1 wherein the stabilizer is disposed on the said rearward lower portion of the body and is horizontally oriented.

7. A mole-plough according to claim 5 wherein the stabilizer is located above the level of the discharge end of the passage.

8. (canceled)

9. Line laying apparatus comprising in combination a mole-plough according to claim 1, a traction unit adapted for connection to the attachment means of the mole-plough, the traction unit having at least one line guide reel mounted thereon, and a line feeding unit adapted to follow the traction unit and the mole-plough and having mounted thereon feed drums providing a line supply to the mole-plough for laying in the subterranean channel formed thereby.
